(19) United States
(12) Patent Application Publication
(10) Pub. No.: US 2013/0002394 A1
(43) Pub. Date: Jan. 3, 2013

(54) BOLOMETER AND METHOD OF MANUFACTURING THE SAME

(76) Inventor: Kaoru Narita, Tokyo (JP)

(21) Appl. No.: 13/635,181

(22) PCT Filed: May 11, 2011
(86) PCT No.: PCT/JP2011/002632

§ 371 Date: Sep. 14, 2012

(30) Foreign Application Priority Data
May 20, 2010 (JP) 2010-115925
Sep. 28, 2010 (JP) 2010-216422

(51) Int. Cl. H01C 1/16; H01C 17/00; B82Y 15/00

(52) U.S. Cl. 338/15; 29/610.1; 977/954

(57) ABSTRACT

A polymer film 102 is formed on a substrate 101, a thermistor resistor 106 is formed on the polymer film 102, and a light reflecting film 104 is formed between the thermistor resistor 106 and the substrate 101. For this reason, if infrared rays or terahertz waves are incident from above, a part is absorbed by the thermistor resistor 106, and most transmits the polymer film 102 and is reflected by the light reflecting film 104. When the distance between the thermistor resistor 106 and the light reflecting film 104 is d, a light component having a wavelength expressed by d=l/4 and equal to or smaller than l resonates and changes to heat, and the temperature of the thermistor resistor 106 rises. A change in resistance with a rise in the temperature of the thermistor resistor 106 is detected, thereby detecting the intensity of an infrared ray or a terahertz wave.

### TECHNICAL FIELD

The present invention relates to a bolometer which detects infrared rays or terahertz waves.

### BACKGROUND ART

The cell structure of a known bolometer will be hereinafter described with reference to FIG. 11. In this bolometer, a diaphragm-type heat insulating portion 4 is provided on a silicon substrate 1 separated by a gap 7 from the silicon substrate 1 with a leg portion 42 as a support, and an infrared detection portion 3 is provided on the heat insulating portion 4. If an infrared ray is irradiated, the infrared detection portion 3 is heated, and a change in resistance with a change in temperature is detected.

Usually, if air is in the gap 7 between the heat insulating portion 4 and the silicon substrate 1, since heat is transferred to the silicon substrate 1 due to thermal conduction of air, a change in temperature of the heat insulating portion 4 decreases, and sensitivity is lowered, this portion is in vacuum. An infrared reflecting film 6 is provided so as to return an infrared ray transmitted the infrared detection portion 3 on the heat insulating portion 4 without being absorbed by the infrared detection portion 3, thereby increasing absorptance (Patent Document 1).

### RELATED DOCUMENT

### Patent Document

[Patent Document 1] Japanese Laid-Open Patent Publication No. 2007-263769

### SUMMARY OF THE INVENTION

### Technical Problem

When producing the structure illustrated in FIG. 11, usually, a silicon micro electro mechanical systems (MEMS) process is used. A manufacturing flow of a typical MEMS process will be hereinafter described with reference to FIG. 12.

First, as illustrated in FIG. 12(a), an insulating interlayer 820 is formed on a semiconductor substrate 801, on which a read circuit having a complementary metal oxide semiconductor (CMOS) transistor or the like is produced, using a chemical vapor deposition (CVD) method, and a metallic infrared reflecting film 804 is formed on the insulating interlayer 820 and patterned.

Thereafter, an insulating interlayer 820 is further formed, and a sacrificial layer 830 is formed on the insulating interlayer 820. In order to produce a structure in which a diaphragm is floated from the semiconductor substrate 801, first, the sacrificial layer 830 is formed, a diaphragm or an infrared detection portion is formed on the sacrificial layer 830, and the sacrificial layer 830 is finally removed through etching.

After the sacrificial layer 830 is formed, as illustrated in FIG. 12(b), a diaphragm film made of a silicon nitride film 831 and a silicon oxide film 832 is formed using a CVD method and patterned. A metal electrode 805 is formed on the sacrificial layer 830 and patterned.

Subsequently, as illustrated in FIG. 12(c), a thermistor resistor 806 in ohmic contact with the metal electrode 805 is formed and patterned. A second silicon nitride film 833 is formed on the thermistor resistor 806, and then an infrared absorbing film 811 is formed and patterned.

Finally, as illustrated in FIG. 12(d), the sacrificial layer 830 is removed through etching to obtain a cell having a diaphragm structure. In the drawing, the distance d between the infrared reflecting film 804 and the infrared absorbing film 811 is usually set to ¼ of a wavelength l for detection with satisfactory sensitivity. That is, when detecting the wavelength l=10 mm, d=2.5 mm is set.

As described above, a complicated manufacturing method is required for producing the structure of the related art, and the number of times of photolithography increases. The diaphragm film is a thin film (about 0.5 mm) formed of the silicon nitride films 831 and 833 and the silicon oxide film 832, and is connected to the semiconductor substrate 801 through a fine beam (1 to 2 mm) so as to retain heat.

For this reason, when etching the sacrificial layer 830, defects, such as sticking of the diaphragm (831 to 833) to the semiconductor substrate 801 by surface tension or warping, are likely occur.

That is, the degree of difficulty of the manufacturing process may be very high. For this reason, since each manufacturing process requires stricter conditioning, and the margin for the found manufacturing conditions is small, fluctuation in the manufacturing conditions largely affects yield.

The thermistor resistor 806 is made of a material whose resistance changes depending on temperature. As a change in resistance with temperature (TCR: Temperature Coefficient of Resistance value) is large, the sensitivity of the sensor increases. Accordingly, vanadium oxide or the like having a large TCR value is usually used.

Vanadium oxide is a material which is not in a usual silicon process, and the TCR value thereof depends largely on a film forming condition or a subsequent heat treatment condition. That is, this means that, in regard to resistor formation, difficult conditioning is required.

In this way, difficulty in manufacturing the diaphragm (831 to 833) structure and difficulty in the method of forming a resistor material affect yield, causing an increase in manufacturing cost. As described above, since the gap between the diaphragm (831 to 833) and the semiconductor substrate 801 should be in vacuum, the sensor chip should be put in a package entirely vacuum-sealed, causing an increase in cost.

As a result, a micro bolometer which is used in an infrared image sensor of the related art uses a silicon MEMS process in a manufacturing process, and since the sensor is packaged in a vacuum-sealed manner, there is a problem in that cost increases inevitably.

When a wave to be detected by a bolometer has a long wavelength like a terahertz wave, it is necessary to increase the distance d between the reflecting film and the absorbing film. For example, when detecting a wave of 1 THz, since the wavelength l=300 mm, it is necessary that d=l/4=75 mm.

In the structure of the related art, as described above, an increase in the distance between the diaphragm (831 to 833) and the semiconductor substrate 801 corresponds to an increase in thickness of the sacrificial layer, and accompanied by difficulty in manufacturing. That is, in the structure of the related art, there is a problem in that it is difficult to manufacture a bolometer having high sensitivity to a terahertz wave.

The invention has been accomplished in consideration of the above-described problems, and an object of the invention is to provide a bolometer capable of being simply manufactured without using an expensive manufacturing apparatus and detecting a terahertz wave or the like which is difficult to detect in the related art, and a method of manufacturing the same.

### Solution to Problem

A bolometer according to the invention includes a substrate, a heat insulating layer which is formed on the substrate, a thermistor resistor which is formed on the heat insulating layer, and a light reflecting film which is formed between the thermistor resistor and the substrate.

A method of manufacturing a bolometer according to the invention includes forming a light reflecting film on a substrate, forming a heat insulating layer on the substrate and the light reflecting film, and forming a thermistor resistor on the heat insulating layer.

Although in the manufacturing method according to the invention, a plurality of manufacturing processes are described in order, this order is not intended to limit the order in which a plurality of manufacturing processes are executed. For this reason, when executing the manufacturing method according to the invention, the order of a plurality of manufacturing processes may be changed without difficulty in terms of contents.

The manufacturing method according to the invention is not limited to a case where a plurality of manufacturing processes are individually executed at different timings. For this reason, another manufacturing process may occur while a certain manufacturing process is executed, the timing for executing a certain manufacturing process and the timing for executing another manufacturing process may overlap each other partially or entirely.

### Advantageous Effect of the Invention

According to the invention, a bolometer which may be simply manufactured without using an expensive manufacturing apparatus and may detect a terahertz wave or the like which is difficult to detect in the related art, and a method of manufacturing the same are realized.

### BRIEF DESCRIPTION OF THE DRAWINGS

The above and other objects, features, and advantages will be apparent from the following embodiment and the accompanying drawings.

FIG. 1 illustrates the structure of a bolometer according to an embodiment of the invention, specifically, FIG. 1(a) is a plan view, and FIG. 1(b) is a sectional view taken along the line A-A′.

FIG. 2 is a plan view illustrating the structure of an image sensor having a bolometer array.

FIG. 3 is a longitudinal sectional front view illustrating the structure of a bolometer of a modification.

FIG. 4 is a longitudinal sectional front view illustrating the structure of a bolometer of another modification.

FIG. 5 is a longitudinal sectional front view illustrating a method of manufacturing a bolometer.

FIG. 6 is a process view illustrating a method of manufacturing a bolometer of a first example.

FIG. 7 is a plan view illustrating the structure of a bolometer array of a second example.

FIG. 8 is a longitudinal sectional front view illustrating the internal structure of a main part of a bolometer array.

FIG. 9 is a process view illustrating a method of manufacturing a bolometer array.

FIG. 10 is a plan view illustrating the overall structure of a bolometer array.

FIG. 11 illustrates the structure of a bolometer of the related art, specifically, FIG. 11(a) is a perspective view, and FIG. 11(b) is a longitudinal sectional front view.

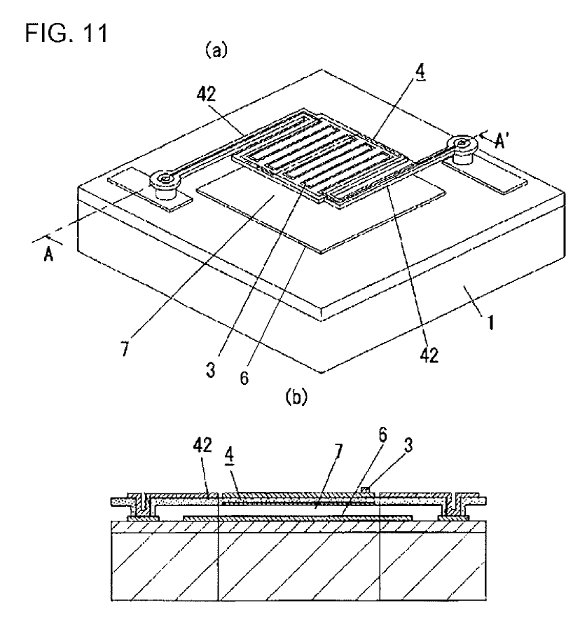

FIG. 12 is a process view illustrates a method of manufacturing a bolometer.

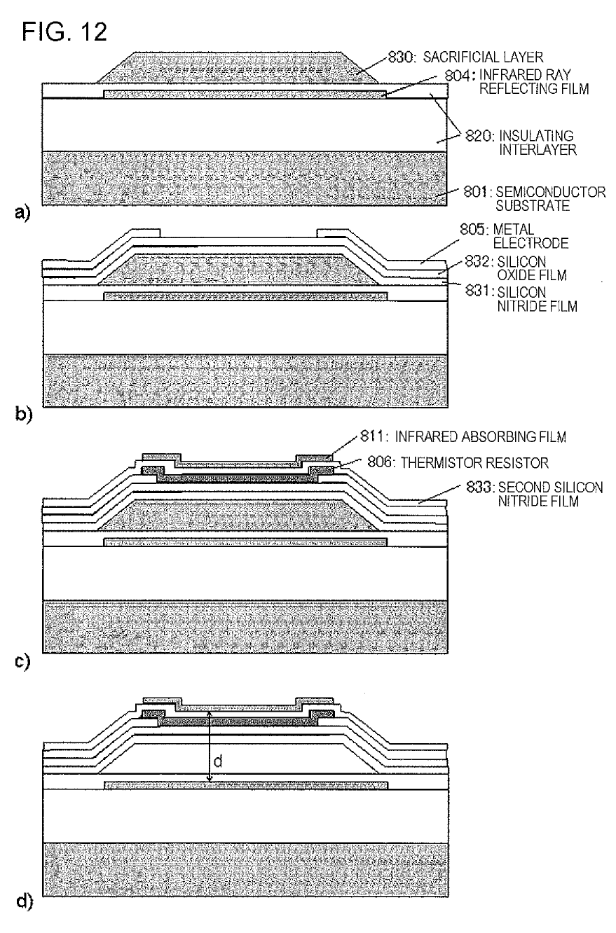

### DESCRIPTION OF EMBODIMENTS

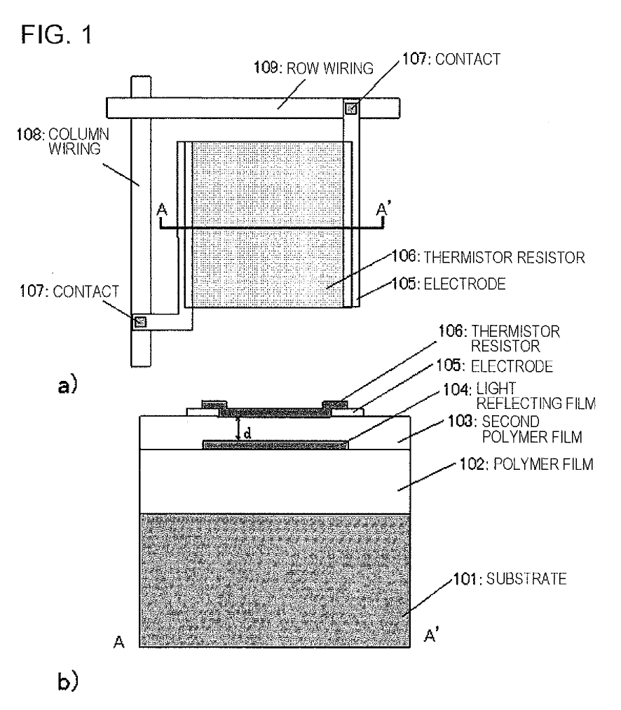

An embodiment of the invention will be hereinafter described with reference to FIG. 1. In this embodiment, the same portions as the related art described above are represented by the same names, and detailed description thereof will not be repeated. FIG. 1 illustrates an infrared sensor cell in which a bolometer according to the embodiment of the invention is used, specifically, FIG. 1(a) is a plan view, and FIG. 1(b) is a sectional view taken along the line A-A′.

A bolometer of this embodiment includes a substrate 101, a polymer film 102 which is formed on the formed on the substrate 101 and serves as a heat insulating layer (low-thermal-conductivity layer), a thermistor resistor 106 which is formed on the polymer film 102, and a light reflecting film 104 which is formed between the thermistor resistor 106 and the substrate 101.

Specifically, in FIG. 1(b), the substrate 101 may be manufactured at low cost using a plastic material, such as polyimide, and allows improvement in sensitivity of a sensor since heat is hard to transfer.

The polymer film 102 on the substrate 101 is formed of a material which is hard to transfer heat, for example, parylene. Parylene is a material which has thermal conductivity of merely about three times higher than air and is hard to transfer heat.

It is necessary that the thermal conductivity of the polymer film 102 of this embodiment is lower than the thermal conductivity of the substrate 101. For example, as described above, when the substrate 101 is made of polyimide, it is necessary that the thermal conductivity of the polymer film 102 is equal to or lower than 0.3 (W/mK). Since there is no polymer film 102 having thermal conductivity lower than air is preferable that the thermal conductivity of the polymer film 102 of this embodiment is 0.02 to 0.3 (W/mK).

Parylene is a general term of paraxylene-based polymers and has a structure in which benzene rings are connected together through CH₂. Examples of parylene include parylene N, parylene C, parylene D, parylene HT, and the like.

Of these, parylene having the lowest thermal conductivity is parylene C, and the thermal conductivity is 0.084 (W/mK). Accordingly, as the polymer film 102 of this embodiment, parylene C is preferably used. In this case, the thermal conductivity is about 3.2 times higher than 0.026 (W/mK) which is the thermal conductivity of air.

The light reflecting film 104 is formed of a metal, for example, an aluminum film. A second polymer film 103 is formed of the same kind of parylene on the light reflecting film 104. It is necessary that this layer satisfactorily transmits an infrared ray, and parylene is suitably used since the infrared transmittance of parylene is high.

An electrode 105 is formed on the second polymer film 103. As the material for the electrode, titanium having low thermal conductivity or the like is desirably used. The thermistor resistor 106 is in ohmic contact with the electrode 105.

For the thermistor resistor 106, a material which undergoes a change in resistance depending on a change in temperature is used. As the ratio (TCR value) of a change in resistance to a change in unit temperature is large, sensitivity as a sensor increases. As the thermistor resistor 106, a coated film which is formed by coating a material with carbon nanotubes dispersed in a solvent is suitably used.

This is because the TCR value of a film formed of a network of carbon nanotubes is high, 0.5 to 2.0%, and the forming method is easily made. The reason why carbon nanotubes are advantageous as a thermistor resistor is that a carbon nanotube film has high absorptance with respect to an infrared ray or a terahertz wave.

As illustrated in FIG. 1(a), the electrode 105 is connected to a row wiring 109 and a column wiring 108 through contactS 107. As the material for the row wiring 109 and the column wiring 108, for example, a metal, such as aluminum, is used.

With the above-described configuration, in the state of FIG. 1(b), if an infrared ray or a terahertz wave is incident from above, while a part is absorbed by the thermistor resistor 106, since the second polymer film 103 is formed of parylene which is likely to transmit an infrared ray or a terahertz wave, most transmits the second polymer film 103, reaches the metallic light reflecting film 104, and is reflected by the light reflecting film 104.

When the distance between the thermistor resistor 106 and the light reflecting film 104 is d, a light component having a wavelength expressed by d=l/4 and equal to or smaller than l resonates and changes to heat, and the temperature of the thermistor resistor rises.

At this time, since the polymer film 102 is formed of parylene having low thermal conductivity, heat is retained, and a significant rise in temperature may be obtained. A change in resistance with a rise in temperature of the thermistor resistor is read from the electrode 105, thereby detecting intensity of an infrared ray.

Since the bolometer of this embodiment does not have the diaphragm structure of the related art, a silicon MEMS process which is necessary for manufacturing the diaphragm structure is not required. For this reason, production is easily done. Vacuum-sealed packaging is not required for vacuumizing between the diaphragm and the substrate 101, thereby contributing in low cost.

That is, in the related art, since a position in the diaphragm structure where air is present is filled with the polymer film 103 having heat insulation and low thermal conductivity, manufacturing is easily done, and a desired frequency may be satisfactorily detected depending on the thickness of the polymer film 103.

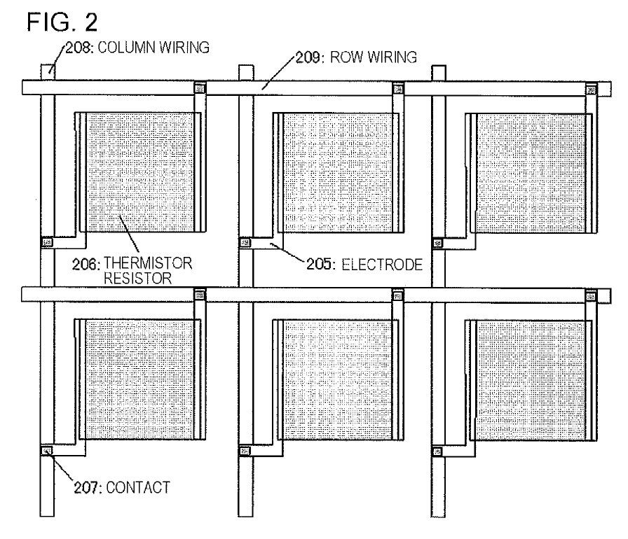

The invention is not limited to this embodiment, and various modifications may be made without departing from the scope of the invention. For example, in the above-described form, a bolometer of one cell is illustrated. However, as illustrated in FIG. 2, thermistor resistors 206 are arranged in an array, and electrodes 205 are connected to a plurality of column wirings 208 of the respective columns through contacts 207 of the respective columns and are connected to a plurality of row wirings 209 of the respective rows through contacts 207. Thus, a two-dimensional image sensor may be obtained.

FIG. 2 is a plan view illustrating an image sensor in which sensor cells of FIG. 1 are arranged in an array. When the thermistor resistors 206 are arranged in an array, each column wiring 208 is shared by cells arranged in the column direction is shared, and each row wiring 209 is shared by cells arranged in the row direction is shared.

In this way, in a structure in which sensor cells each having a bolometer are arranged in an array, electrical signals are given to the row wiring 209 and the column wiring 208 corresponding to each cell, and a change in resistance of the cell is read. Accordingly, it is possible to sequentially changes in resistance of all cells. Therefore, it is possible to construct an infrared image sensor.

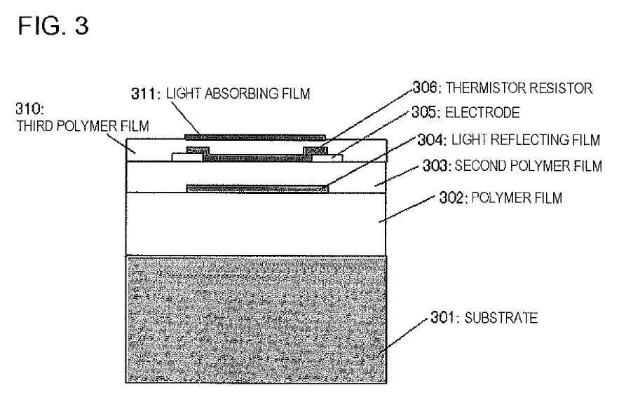

In a bolometer illustrated in FIG. 3, a third polymer film 310 formed of parylene is further provided on the thermistor resistor 306, and a light absorbing layer 311 which satisfactorily absorbs an infrared ray or a terahertz wave is provided on the third polymer film 310. In this case, for the light absorbing layer 311, a carbon nanotube film or a thin film made of titanium nitride may be used.

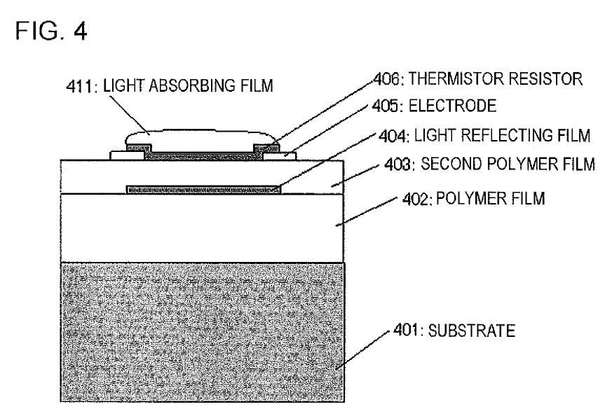

In a bolometer illustrated in FIG. 4, a light absorbing layer 411 is formed on a thermistor resistor 406. In this case, as the light absorbing layer 411, a coated film of polyimide molten in an organic solvent, or the like may be used.

As illustrated in FIG. 3 or 4, if the light absorbing layer 311 or 411 is provided in the bolometer, since absorptance of an infrared ray or a terahertz wave increases, and absorptance of substantially 100% may be obtained, a higher rise in temperature is obtained.

As another candidate for the material of the thermistor resistor 106 (206, 306, 506, 406, 606), a mixture of silicon and germanium is considered. While the formation of a mixture of silicon and germanium is not easily done compared to carbon nanotubes, it is known that the mixture has a high TCR value equal to or greater than 3%, thereby increasing sensitivity of the sensor.

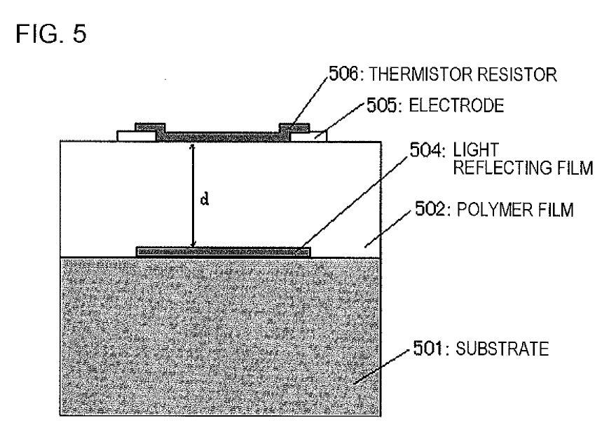

Hereinafter, a specific example of a method of manufacturing a bolometer of this embodiment will be simply described with reference to FIG. 5. In FIG. 5, a substrate 501 is formed of plastic, such as polyimide. A light reflecting film 504 is formed of an aluminum film on the substrate 501.

A polymer film 502 is formed of parylene on the light reflecting film 504. An electrode 505 and a thermistor resistor 506 are provided on the polymer film 502. A difference from FIG. 1 is that the light reflecting film 504 is formed directly on the substrate 501.

In this way, since the distance d (=l/4) between the light reflecting film 504 and the thermistor resistor 506 is large, it is possible to increase sensitivity with respect to light having long wavelength. For example, if d=75 mm, the wavelength (terahertz wave of 1 THz) of l=300 mm may be detected.

In this case, while the polymer film 502 should have high transmittance with respect to an infrared ray or a terahertz wave and low thermal conductivity, since parylene satisfies both conditions, parylene may be an appropriate material.

Of course, the foregoing embodiment and various modifications may be combined within the scope in which the contents are consistent. Although in the foregoing embodiment and the modifications, the structure of each portion and the like have been specifically described, the structure and the like may be changed in various forms within the scope satisfying the invention.

### First Example

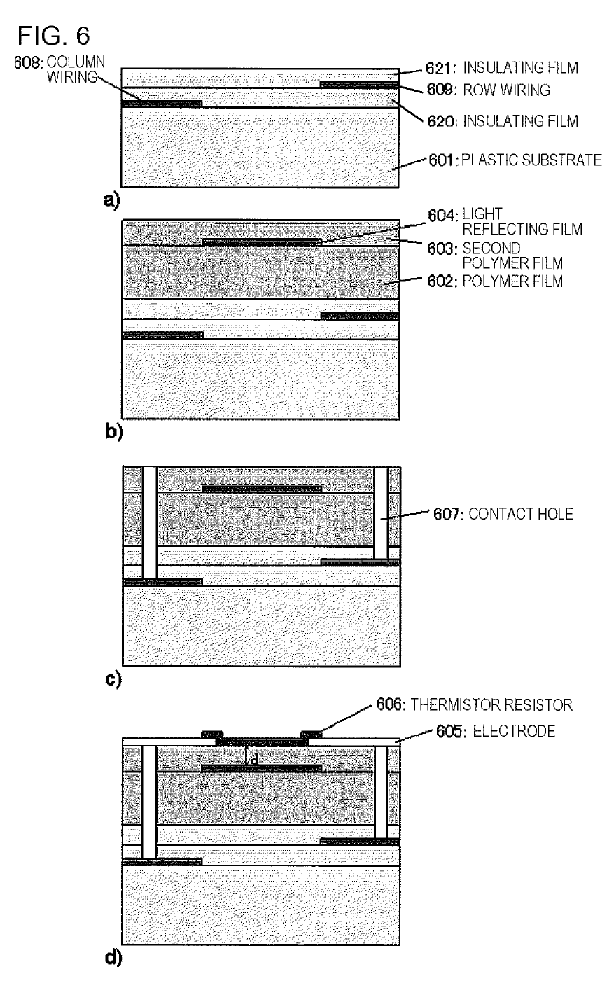

As a first example of the invention, a method of manufacturing a bolometer will be hereinafter described in detail with reference to FIG. 6. In FIG. 6(a), a metal mask of an aluminum film (1000 Å) is deposited on a plastic substrate 601 made of polyimide to form a column wiring 608.

Next, polyimide is coated to form an insulating film 620. Similarly to the column wiring, a row wiring 609 is formed on the insulating film 620. Polyimide is further coated on the row wiring 609 to form a second insulating film 621.

Next, as shown in FIG. 6(b), as a polymer film 602, a parylene film is formed to have a thickness of about 20 mm through deposition. While parylene is usually in a dimer state, parylene is heated to about 700° C. in a deposition apparatus and placed in a monomer state, and is placed in a polymer state after having been deposited on the substrate.

Next, a light reflecting film 604 is formed on the polymer film 602 through aluminum (1000 Å) deposition, and a second polymer film 603 is formed on the light reflecting film 604 to have a thickness of about 2.5 mm through parylene deposition.

Next, as shown in FIG. 6(c), a contact hole 607 is formed through lithography and dry etching. Next, as shown in FIG. 6(d), an electrode 605 connected to the row wiring and the column wiring through contact holes 607 is formed using a titanium film (1000 Å) through sputtering and patterned through lithograph and liftoff.

Thereafter, a thermistor resistor 606 is formed using a carbon nanotube film. The carbon nanotube file can be formed by coating a solution, in which carbon nanotubes are ultrasonically dispersed in an organic solvent, using a dispenser.

Finally, as shown in FIG. 6(d), a sensor in which the distance d (=l/4) between the light reflecting film 604 and the thermistor resistor 606 is d=2.5 mm, that is, a sensor with high sensitivity with respect to a far-infrared ray having the wavelength l of 10 mm may be formed.

### Second Example

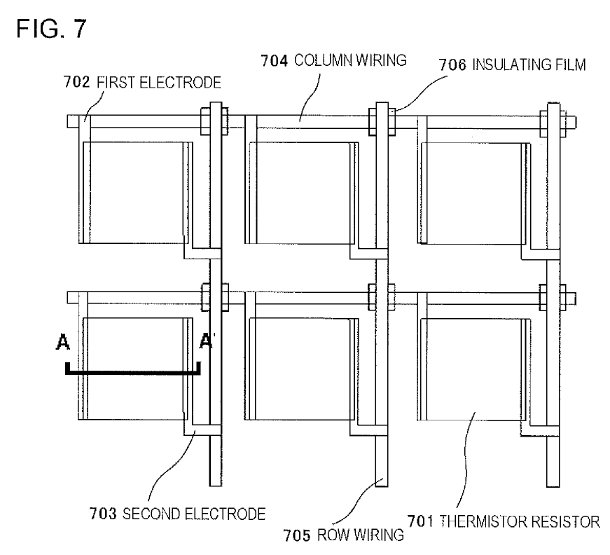

Next, as a second example of the invention, a bolometer array will be hereinafter described with reference to FIG. 7. FIG. 7 is a plan view of an example of a bolometer array of the invention. Here, an example where six bolometers in total of two rows and three columns are arranged will be described.

A first electrode 702 and a second electrode 703 are connected to a thermistor resistor 701 of each bolometer. The first electrode 702 is connected to a column wiring 704, and the second electrode 703 is connected to a row wiring 705.

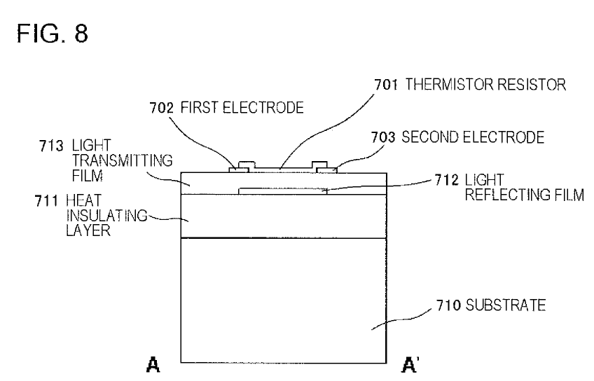

The column wiring 704 and the row wiring 705 are electrically insulated from each other by an insulating film 706. FIG. 8 is a sectional view taken along the line A-A′ of FIG. 7. As shown in FIG. 8, a heat insulating layer 711 is provided on a substrate 710, a light reflecting film 712 is provided on the heat insulating layer 711, a light transmitting layer 713 is provided, and the thermistor resistor 701 connected to the first electrode 702 and the second electrode 703 is provided.

With this structure, contacts and a bolometer array may be formed. Although lithography and etching are usually required so as to form the contacts, according to the invention, lithography and etching are not required, and manufacturing may be done through printing or the like, thereby realizing low cost.

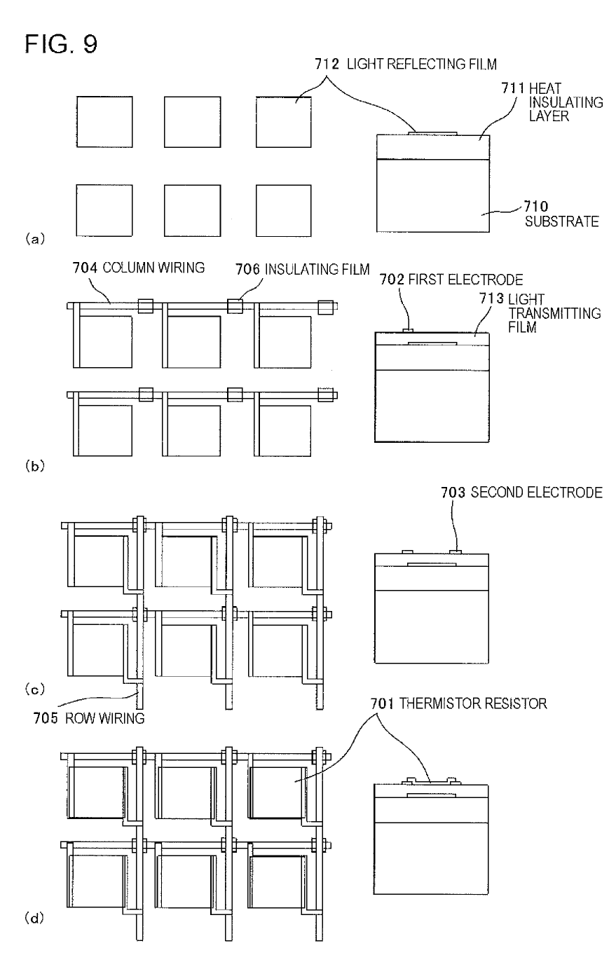

FIGS. 9(a) to 9(d) are diagrams illustrating a method of manufacturing a bolometer array of the invention. As shown in FIG. 9(a), the heat insulating layer 711 is formed on the substrate 710, and the light reflecting film 712 is formed on the heat insulating layer 711.

As the substrate, polyimide resin or the like may be used. The heat insulating layer is desirably formed of parylene having low thermal conductivity. If the thickness of parylene is about 10 to 20 μm, this sufficiently functions as the heat insulating layer.

The light reflecting film may be formed by a method of depositing a metal, for example, aluminum or gold. If the thickness of the light reflecting film is about 100 nm, this functions as a reflecting film. Next, as shown in FIG. 9(b), the light transmitting layer 713 is formed, and the first electrode 702 and the column wiring 704 are formed on the light transmitting layer 713.

In this case, as the light transmitting layer, parylene which is likely to transmit an infrared ray is desirably used. The first electrode and the column wiring may be formed of the same material simultaneously. As the forming method, a method of forming the first electrode and the column wiring by depositing a metal, such as aluminum or gold is considered. The first electrode and the column wiring may be formed of a material, such as nanosilver, through printing.

Next, in order to insulate a portion of the column wiring 704 and a portion crossing the row column in a subsequent process, the insulating film 706 is formed. As the method of forming the insulating film, a method of coating and forming polyimide through printing is used.

Next, as shown in FIG. 9(c), the second electrode 703 and the row wiring 705 are formed. In this case, as the forming method, the same method as the method of forming the first electrode and the column wiring may be used.

Next, as illustrated in FIG. 9(d), the thermistor resistor 701 which is connected to the first and second electrodes is formed. As the thermistor resistor, a mat-shaped sheet of carbon nanotubes or the like may be used. For example, carbon nanotubes dispersed in a solvent may be coated and the solvent may be evaporated, thereby forming the thermistor resistor.

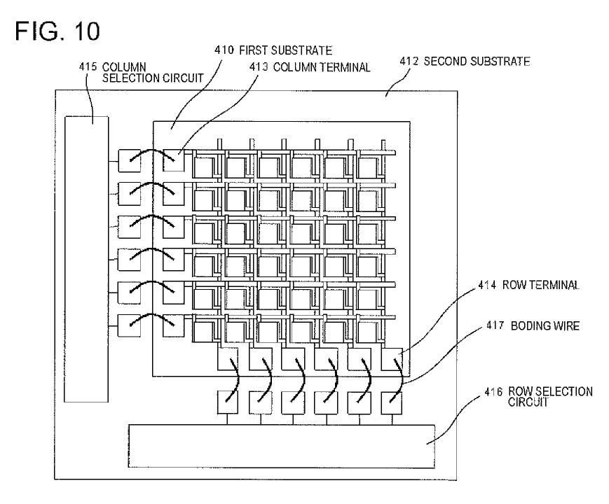

FIG. 10 illustrates an example of a device in which a bolometer array of the invention is a read circuit are connected together. That is, a bolometer array is formed on a first substrate 410 of FIG. 10. A column terminal 413 is formed at one end of each column wiring, and a row terminal 414 is formed at one end of each row wiring.

A second substrate 412 is, for example, a substrate made of silicon semiconductor, and a read circuit of a bolometer is formed on the substrate using an integrated circuit through a CMOS process (not shown). An insulating layer is formed on the read circuit, and the first substrate is bonded to the second substrate.

The column terminals 413 and the row terminals 414 are electrically connected to the terminals connected to a column selection circuit 415 and a row selection circuit 416 in the read circuit formed on the second substrate. Although in this case, connection is made using bonding wires 417, another method in which metal balls are formed on the terminals and a flexible cable is pressed may be used.

In this way, the method in which the bolometer array is formed on the resin substrate, the read circuit is formed of a semiconductor, and these are connected together using a mounting technique is used, making it possible to reduce total manufacturing cost.

That is, as described above, the reason is that the bolometer array may be formed on the resin substrate with a low-cost process, and if a usual silicon CMOS process is used, the read circuit may be formed on the semiconductor substrate at low cost.

This application claims priority based on Japanese Patent Application No. 2010-115925 filed on May 20, 2010 and Japanese Patent Application No. 2010-216422 filed on Sep. 28, 2010, the entire disclosures of which are incorporated herein.

1. A bolometer comprising:
a substrate;
a heat insulating layer which is formed on the substrate;
a thermistor resistor which is formed on the heat insulating layer; and
a light reflecting film which is formed between the thermistor resistor and the substrate.

2. The bolometer according to claim 1,
wherein the heat insulating layer is made of parylene.

3. The bolometer according to claim 1,
wherein an interlayer film between the thermistor resistor and the light reflecting film is made of parylene.

4. The bolometer according to claim 1, wherein the substrate is made of resin.

5. The bolometer according to claim 1, further comprising:
a light absorbing layer which is formed in the vicinity of the thermistor resistor and thermally coupled to the thermistor resistor.

6. The bolometer according to claim 5,
wherein the light absorbing layer contains carbon nanotubes.

7. The bolometer according to claim 5,
wherein the light absorbing layer is made of an organic material.

8. The bolometer according to claim 1, wherein the thermistor resistor contains carbon nanotubes.

9. The bolometer according to claim 1, wherein the thermistor resistor contains silicon and germanium.

10. A method of manufacturing a bolometer, the method comprising:
forming a light reflecting film on a substrate;
forming a heat insulating layer on the substrate and the light reflecting film; and
forming a thermistor resistor on the heat insulating layer.
